(19) United States
(12) Patent Application Publication
(10) Pub. No.: US 2016/0154665 A1
(43) Pub. Date: Jun. 2, 2016

(54) VIRTUAL MACHINE DEPLOYMENT METHOD, VIRTUAL MACHINE DEPLOYMENT PROGRAM, AND VIRTUAL MACHINE DEPLOYMENT SYSTEM

(71) Applicant: FUJITSU LIMITED, Kawasaki-shi (JP)

(72) Inventors: Fumi Iikura, Shinagawa (JP); YASUHIDE MATSUMOTO, Kawasaki (JP)

(73) Assignee: FUJITSU LIMITED, Kawasaki-shi (JP)

(21) Appl. No.: 14/925,028

(22) Filed: Oct. 28, 2015

(30) Foreign Application Priority Data
Nov. 28, 2014 (JP) 2014-241009

(51) Int. Cl. G06F 9/455; H04L 12/26

(52) U.S. Cl. CPC G06F 9/45558; H04L 43/04; H04L 43/0805; G06F 2009/4557; G06F 2009/45595; G06F 2009/45591

(57) ABSTRACT

A virtual machine deployment method includes acquiring, by a processor, a template in which definition information is described for deploying a virtual machine, specifying, by a processor, a monitored object to be monitored by a monitoring device from information included the acquired template, generating, by a processor, monitoring definition information that enables the monitoring device to monitor the specified monitored object from monitoring information which associates the specified monitored object with information on a monitoring item that can be monitored by the monitoring device, and deploying, by a processor, the virtual machine based on the acquired template to which a description of the generated monitoring definition information has been added.

### CROSS-REFERENCE TO RELATED APPLICATION

This application is based upon and claims the benefit of priority of the prior Japanese Patent Application No. 2014-241009, filed on Nov. 28, 2014, the entire contents of which are incorporated herein by reference.

### FIELD

The present invention relates to a virtual machine deployment method, a virtual machine deployment program, and a virtual machine deployment system.

### BACKGROUND

In recent years, with improved performances of physical devices (hereinafter, also referred to as physical machines), research on a virtualization technique for integrating a plurality of virtual devices (hereinafter, also referred to as virtual machines) into one physical machine is being promoted. In the virtualization technique, for example, virtualization software (hypervisor) allocates physical resources of a physical machine to a plurality of virtual machines to enable each virtual machine to provide services.

When constructing a system constituted by virtual machines (hereinafter, also simply referred to as a system) as described above, there may be cases where a service provider providing a service (hereinafter, also simply referred to as a business operator) prepares, in advance, a template (hereinafter, also referred to as template information) that is a set of definition information to (used to) construct the system (that enables the system to be constructed). The template is created based on, for example, information on a system previously constructed by the service provider. By constructing a system based on a template, the service provider can reduce the time or trouble required (that is spent) to construct the system (for example, refer to Japanese National Publication of International Patent Application No. 2007-509404, Japanese National Publication of International Patent Application No. 2009-510635, and Japanese Laid-open Patent Publication No. 2011-233146).

### SUMMARY

With respect to a system such as that described above, a service provider may deploy a monitoring device for monitoring virtual machines in operation. The monitoring device is configured to, for example, acquire information related to an execution state of a process that runs on the virtual machines and perform operation management of the respective virtual machines.

For example, a system such as that described above may include a function for periodically determining an operational state of virtual machines and automatically creating a new virtual machine or automatically deleting a virtual machine (hereinafter, this function will also be referred to as an auto-scaling function). In this case, the monitoring device must start (starts) monitoring of a new virtual machine in accordance with the creation of the new virtual machine and must end (ends) monitoring of a deleted virtual machine in accordance with the deletion of the virtual machine. Therefore, since the monitoring device must also monitor (also monitors) increases and decreases of virtual machines, processing load on the monitoring device increases accordingly.

According to an aspect of the embodiment, a virtual machine deployment method includes acquiring, by a processor, a template in which definition information is described for deploying a virtual machine, specifying, by a processor, a monitored object to be monitored by a monitoring device from information included the acquired template, generating, by a processor, monitoring definition information that enables the monitoring device to monitor the specified monitored object from monitoring information which associates the specified monitored object with information on a monitoring item that can be monitored by the monitoring device, and deploying, by a processor, the virtual machine based on the acquired template to which a description of the generated monitoring definition information has been added.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overall configuration of an information processing system.

FIGS. 2 to 4 are diagrams explaining monitoring of a virtual machine.

FIG. 5 is a diagram illustrating a hardware configuration of the management server 1.

FIGS. 6 and 7 are functional block diagrams of the information processing system illustrated in FIG. 5.

FIG. 8 is a flow chart illustrating an outline of a virtual machine deploying process according to the first embodiment.

FIG. 9 is a diagram for explaining an outline of a virtual machine deploying process according to the first embodiment.

FIGS. 10 to 12 are flow charts describing details of the virtual machine deploying process according to the first embodiment.

FIG. 13 is a diagram explaining a specific example of a configuration of the template information 131.

FIG. 14 is a diagram explaining a specific example of monitoring information 132.

FIG. 15 is a diagram explaining a specific example of the template information 131.

FIG. 16 represents a specific example of the monitoring design information 133.

FIGS. 17 and 18 illustrate a screen through which the user information requesting unit 115 requests the user to input information.

FIG. 19 is a diagram explaining monitoring design information 133 in a case where the user information input in S16 is set to the monitoring design information 133 to which the monitoring information 132 acquired in S14 is set.

FIG. 20 is a diagram explaining a specific example of a configuration of the template information 131.

### DESCRIPTION OF EMBODIMENTS

[Configuration of Information Processing System]

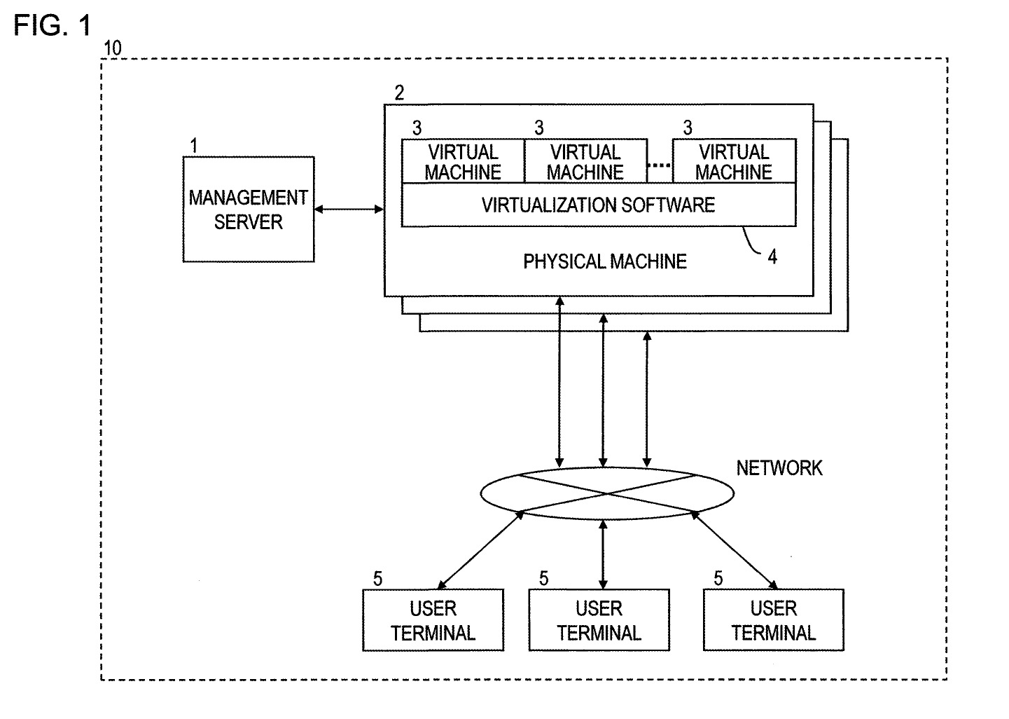

FIG. 1 is a diagram illustrating an overall configuration of an information processing system. With an information processing system 10 illustrated in FIG. 1, for example, a management server 1 (hereinafter, also referred to as a first physical machine 1) and a physical machine 2 (hereinafter, also referred to as a second physical machine 2) in which virtual machines (VMs) 3 and virtualization software 4 operate are provided in a data center. The data center is configured to be accessible from a user terminal 5 via a network such as the Internet and an intranet.

In the example illustrated in FIG. 1, the physical machine 2 is constituted by a plurality of physical machines, and each physical machine includes a central processing unit (CPU), a random access memory (RAM), a large capacity memory such as a hard disk drive (HDD), and a network. Resources of the physical machine 2 are allocated to a plurality of virtual machines 3.

For example, the management server 1 is capable of accessing the physical machine 2, and issues an instruction to create a virtual machine 3 in the physical machine 2 and manages a created virtual machine 3.

With the virtual machine 3, for example, the service provider provides a user with an infrastructure or the like as a service (for example, a cloud service) via a network. A cloud service is a service for providing, via a network, a foundation that enables a computer system to be constructed and operated or, in other words, an infrastructure itself such as the virtual machines 3 and a network. For example, a user accesses a cloud service portal site from the user terminal 5, selects specifications required of (of) a virtual machine such as a clock frequency of a CPU, a capacity (GB) of a memory, a capacity (GB) of a hard disk, and a communication bandwidth (Gbps) of a network, and enters into a cloud use contract with respect to the specifications. Furthermore, for example, the user terminal 5 enables an operational state of the virtual machine 3 to be monitored and enables operations to be performed on the virtual machine 3.

The virtualization software 4 is base software that enables the virtual machine 3 to operate by allocating resources of the physical machine 2 such as a CPU, a memory, a hard disk, and a network in accordance with an instruction from the management server 1. The virtualization software 4 runs on, for example, the physical machine 2.

In addition to being allocated resources of the physical machine 2, for example, the virtual machine 3 includes an image file containing an operating system (OS), middleware, an application, a database, and the like in a hard disk thereof. Furthermore, for example, upon startup, the virtual machine 3 writes the image file from the hard disk onto the memory and performs an operation corresponding to a desired service.

[Monitoring of Virtual Machine]

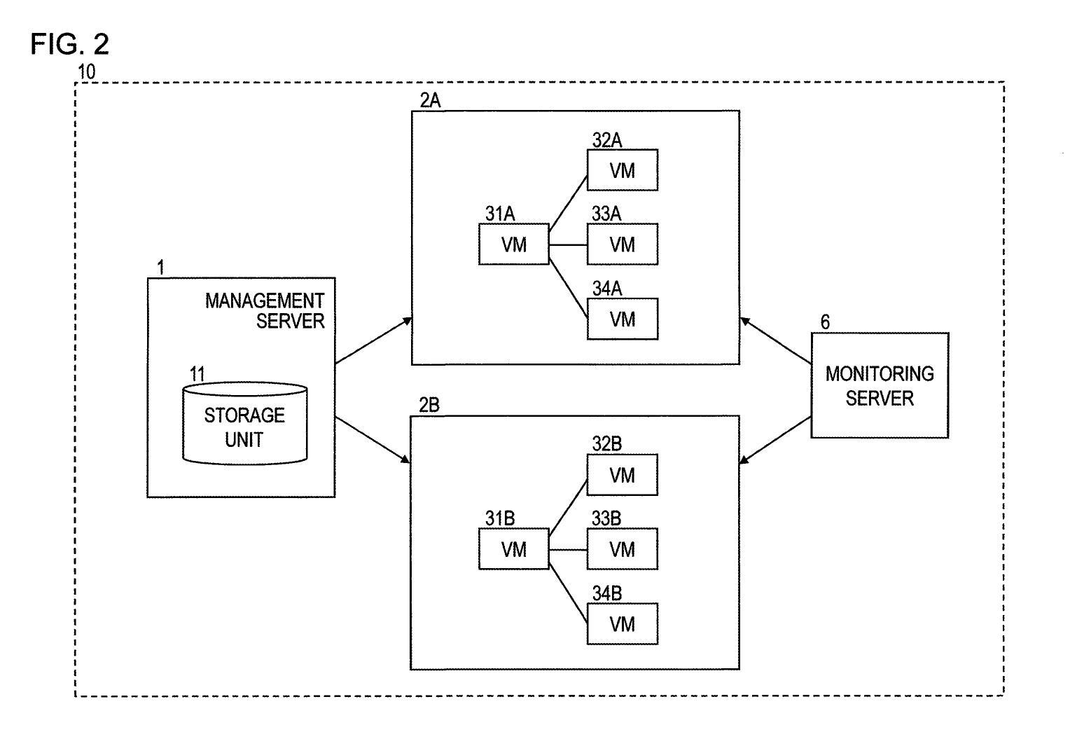

Next, monitoring of a virtual machine will be described. FIGS. 2 to 4 are diagrams explaining monitoring of a virtual machine.

The information processing system 10 illustrated in FIG. 2 is provided with the management server 1, a physical machine 2A, a physical machine 2B, and a monitoring server 6 (hereinafter, also referred to as a monitoring device 6) that monitors a virtual machine 31A and the like created in the physical machines 2A and 2B.

In the example illustrated in FIG. 2, the management server 1 includes a storage unit 11 storing a template for creating each virtual machine. Virtual machines 31A, 32A, 33A, and 34A are created in the physical machine 2A, and virtual machines 31B, 32B, 33B, and 34B are created in the physical machine 2B. Furthermore, the monitoring device 6 performs operation management of each virtual machine based on, for example, information periodically transmitted from each virtual machine in the physical machine 2A and the physical machine 2B. Moreover, hereinafter, it is assumed that the monitoring device 6 monitors all virtual machines that run in the physical machines 2A and 2B. For example, the management server 1 may cause a part of the virtual machines created in the physical machines 2A and 2B to function as the monitoring device 6.

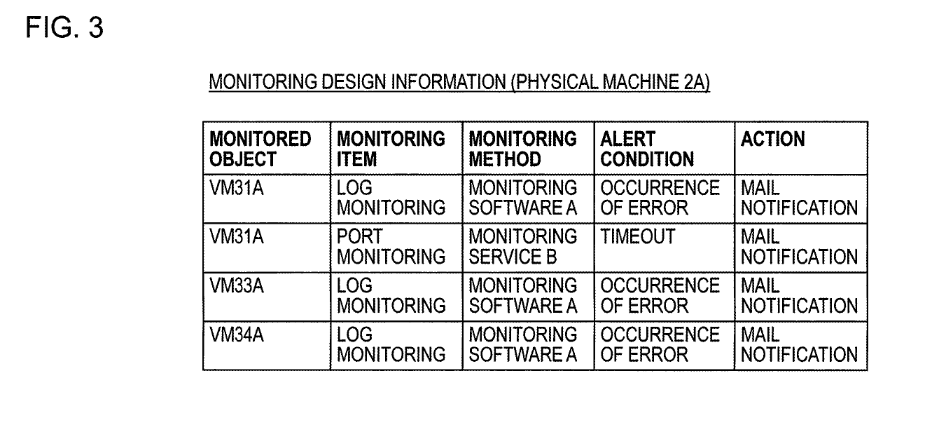

Next, monitoring design information used by the monitoring device 6 to monitor virtual machines will be described. FIG. 3 represents a specific example of the monitoring design information used by the monitoring device 6 to monitor virtual machines in the physical machine 2A illustrated in FIG. 2. The monitoring design information illustrated in FIG. 3 includes a “monitored object” that identifies a monitored object, a “monitoring item” that identifies contents of the monitoring performed on the monitored object, and a “monitoring method” that identifies a monitoring method for realizing monitoring corresponding to the monitoring item. The “monitored object” may be, for example, a virtual machine itself or individual software that runs on a virtual machine. For example, information identifying software that monitors virtual machines may be set to the “monitoring method”. Furthermore, the monitoring design information illustrated in FIG. 3 includes “alert information” that is information related to a condition causing an alert to be generated and an “action” that is information related to a method of generating an alert.

Specifically, in the monitoring design information illustrated in FIG. 3, for information in which the “monitored object” is “VM31A”, “log monitoring” is set as the “monitoring item” and “monitoring software A” is set as the “monitoring method”. For information in which the “monitored object” is “VM31A”, “occurrence of error” is set as the “alert condition” and “mail notification” is set as the “action”. Furthermore, in the monitoring design information illustrated in FIG. 3, for information in which the “monitored object” is “VM31A”, “port monitoring” is set as the “monitoring item” and “monitoring service B” is set as the “monitoring method”. For information in which the “monitored object” is “VM31A”, “timeout” is set as the “alert condition” and “mail notification” is set as the “action”. Furthermore, in the monitoring design information illustrated in FIG. 3, for information in which the “monitored object” is “VM34A”, “log monitoring” is set as the “monitoring item” and “monitoring software A” is set as the “monitoring method”. For information in which the “monitored object” is “VM34A”, “occurrence of error” is set as the “alert condition” and “mail notification” is set as the “action”. A description of other pieces of information illustrated in FIG. 3 will be omitted. Moreover, “VM31A”, “VM33A”, and “VM34A” illustrated in FIG. 3 respectively correspond to virtual machines 31A, 33A, and 34A illustrated in FIG. 2.

Therefore, for example, the monitoring device 6 performs log monitoring using monitoring software A on the virtual machine 31A illustrated in FIG. 2 based on the monitoring design information illustrated in FIG. 3. When an error occurs in the virtual machine 31A, for example, the monitoring device 6 performs a mail notification to an operation manager of information related to the occurred error. Furthermore, the monitoring device 6 performs log monitoring by the monitoring service B on the virtual machine 31A. When a timeout occurs in the virtual machine 31A, for example, the monitoring device 6 performs a mail notification to an operation manager of information related to the occurred timeout. Furthermore, the monitoring device 6 performs log monitoring using monitoring software A on the virtual machine 34A. When an error occurs in the virtual machine 34A, for example, the monitoring device 6 performs a mail notification to an operation manager of information related to the occurred error.

Moreover, only information related to the virtual machines 31A, 33A, and 34A are set in the monitoring design information illustrated in FIG. 3. Therefore, in the example illustrated in FIG. 3, the monitoring device 6 monitors the virtual machines 31A, 33A, and 34A but does not monitor the virtual machine 32A.

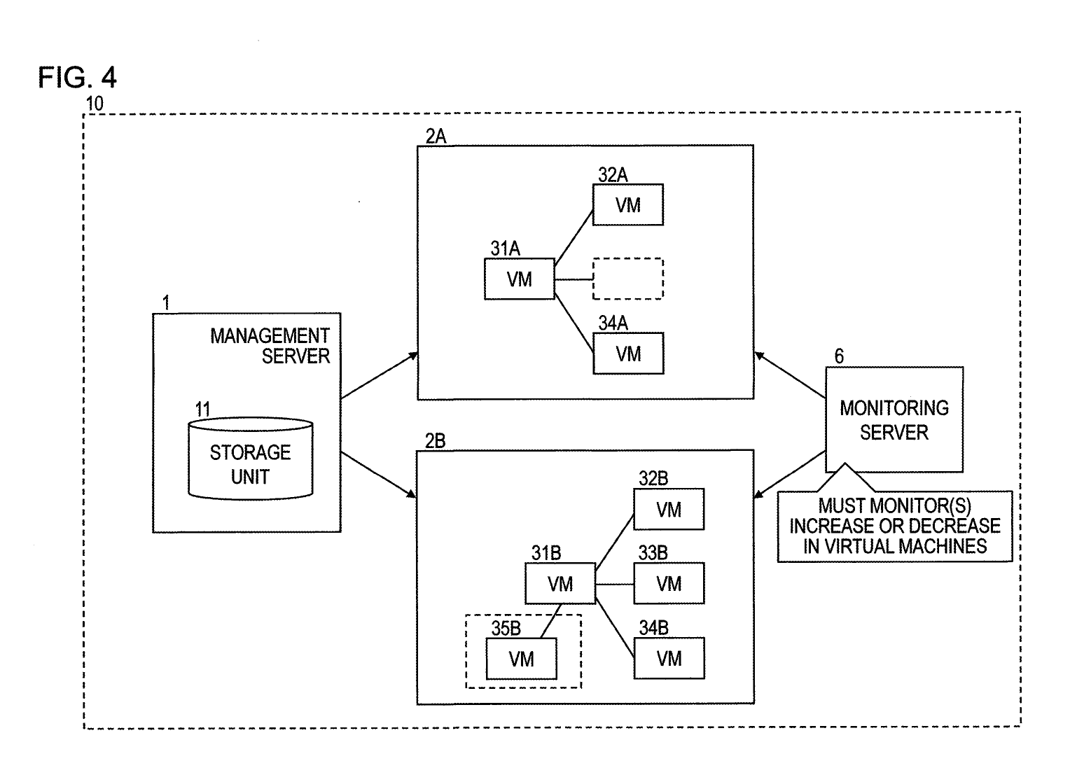

FIG. 4 is a diagram illustrating a case where, after the state illustrated in FIG. 2, a new virtual machine has been created or a virtual machine has been deleted. In the example illustrated in FIG. 4, after the state illustrated in FIG. 2, the virtual machine 33A in the physical machine 2A has been deleted and a virtual machine 35B has been newly created in the physical machine 2B.

In this case, when the virtual machines in the physical machine 2A and the physical machine 2B have an auto-scaling function, the creation of a new virtual machine or a deletion of a virtual machine as illustrated in FIG. 4 is performed automatically. Specifically, for example, the virtual machines 31A and 31B respectively function as load balancers that manage loads on virtual machines inside the physical machines 2A and 2B and create a new virtual machine or deletes a virtual machine as necessary.

In this case, the monitoring device 6 must change (changes) a virtual machine to be monitored in accordance with the creation or deletion of a virtual machine. However, for example, there may be cases where an administrator of the monitoring device 6 is a user of a virtual machine and, in contrast, an administrator of the physical machines 2A and 2B is the service provider. For example, there may be cases where the monitoring device 6 managed by a user is unable to acquire information related to creation or deletion of a virtual machine in the physical machines 2A and 2B. Therefore, in this case, the monitoring device 6 must continuously monitor (continuously monitors) whether or not a creation or a deletion of a virtual machine is performed in the physical machines 2A and 2B and, as a result, load increases.

In consideration thereof, in the present embodiment, the management server 1 creates definition information based on a monitored object specified from a template and monitoring item information (hereinafter, also simply referred to as a monitoring item) for monitoring the specified monitored object. The management server 1 adds the created definition information to the template and deploys virtual machines based on the added template. Accordingly, the monitoring device 6 can acquire information related to the start or the end of monitoring from a deployed virtual machine. Therefore, the monitoring device 6 no longer needs to monitor the creation or deletion of a virtual machine and a load caused by monitoring virtual machines can be reduced.

[Hardware Configuration of Information Processing System 10]

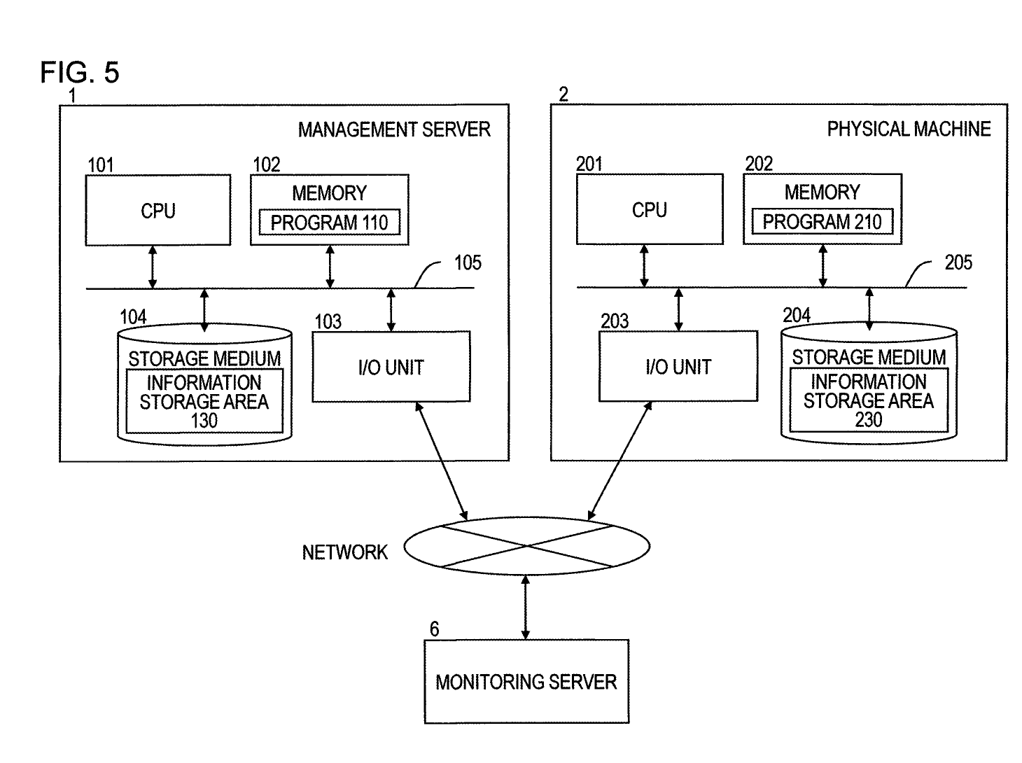

Next, a hardware configuration of the information processing system 10 will be described. FIG. 5 is a diagram illustrating a hardware configuration of the management server 1. The management server 1 includes a CPU 101 that is a processor, a memory 102, an external interface (I/O unit) 103, and a storage medium 104. The respective units are connected to each other via a bus 105.

For example, the storage medium 104 stores a program 110 for performing a process (hereinafter, also referred to as a virtual machine deploying process) of deploying virtual machines in the physical machine 2 or the like in a program storage area (not illustrated) in the storage medium 104. As illustrated in FIG. 5, upon executing the program 110, the CPU 101 loads the program 110 from the storage medium 104 to the memory 102 and performs the virtual machine deploying process in cooperation with the program 110. For example, the storage medium 104 includes an information storage area 130 (hereinafter, also referred to as a storage unit 130) that stores information used when performing the virtual machine deploying process. Moreover, the information storage area 130 corresponds to the storage unit 11 illustrated in FIG. 2 and the like.

Next, a hardware configuration of the physical machine 2 will be described. The physical machine 2 includes a CPU 201 that is a processor, a memory 202, an external interface (I/O unit) 203, and a storage medium 204. The respective units are connected to each other via a bus 205. For example, the storage medium 204 stores a program 210 for performing a process (hereinafter, also referred to as a virtual machine monitoring process) that enables the monitoring device 6 that is the virtual machine 3 deployed in the physical machine 2 to monitor a monitored object or the like in a program storage area (not illustrated) in the storage medium 204. As illustrated in FIG. 5, upon executing the program 210, the CPU 201 loads the program 210 from the storage medium 204 to the memory 202 and performs the virtual machine monitoring process in cooperation with the program 210. For example, the storage medium 204 includes an information storage area 230 (hereinafter, also referred to as a storage unit 230) that stores information used when performing the virtual machine monitoring process. Moreover, the physical machine 2 illustrated in FIG. 5 may be constituted by the physical machine 2A and the physical machine 2B as illustrated in FIG. 2 or the like or may be constituted by three or more physical machines.

[Functions of Information Processing System]

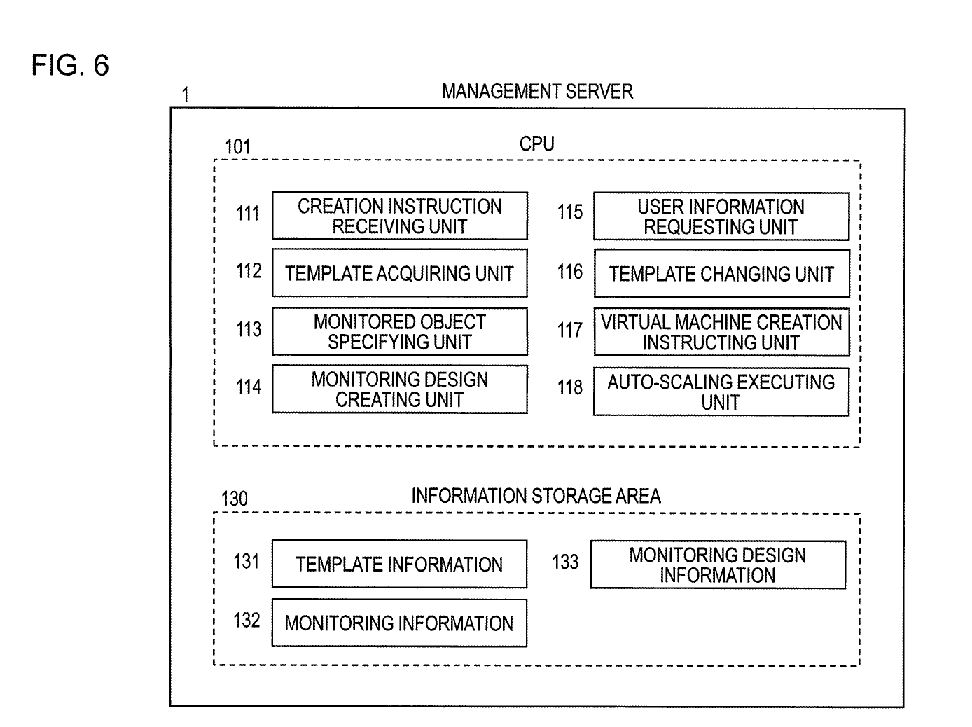

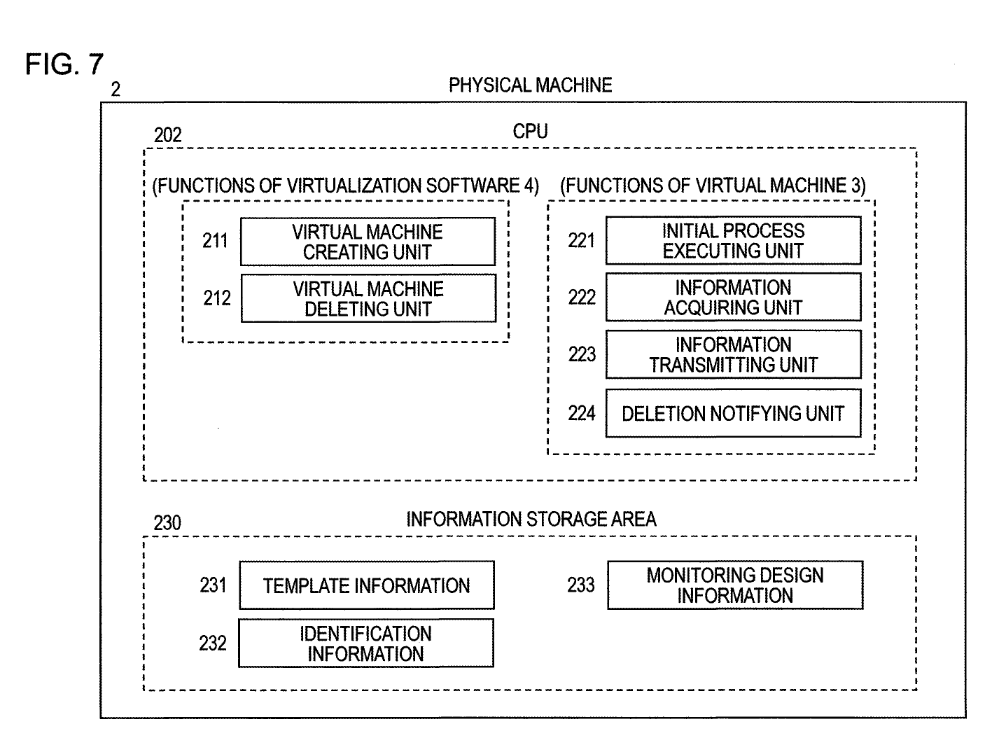

FIGS. 6 and 7 are functional block diagrams of the information processing system illustrated in FIG. 5. By cooperating with the program 110, the CPU 101 of the management server 1 operates as, for example, a creation instruction receiving unit 111, a template acquiring unit 112, a monitored object specifying unit 113, and a monitoring design creating unit 114 as illustrated in FIG. 6. Furthermore, by cooperating with the program 110, the CPU 101 operates as, for example, a user information requesting unit 115, a template changing unit 116, a virtual machine creation instructing unit 117, and an auto-scaling executing unit 118. Template information 131, monitoring information 132, and monitoring design information 133 are stored in the information storage area 130. Moreover, hereinafter, the creation instruction receiving unit 111, the template acquiring unit 112, the monitored object specifying unit 113, the monitoring design creating unit 114, the user information requesting unit 115, the template changing unit 116, the virtual machine creation instructing unit 117, and the auto-scaling executing unit 118 will also be collectively referred to as a processing unit 120.

By cooperating with the program 210, the CPU 201 of the physical machine 2 operates as, for example, a virtual machine creating unit 211 and a virtual machine deleting unit 212 which are functions of the virtualization software 4 as illustrated in FIG. 7. By cooperating with the program 210, the CPU 201 of the physical machine 2 operates as, for example, an initial process executing unit 221, an information acquiring unit 222, an information transmitting unit 223, and a deletion notifying unit 224 which are functions of the virtual machine 3 as illustrated in FIG. 7. Furthermore, template information 231, identification information 232, and monitoring design information 233 are stored in the information storage area 230.

[Functions of Management Server]

The creation instruction receiving unit 111 of the management server 1 receives, for example, an instruction (hereinafter, also simply referred to as a creation instruction) for creating a system including the virtual machine 3 from a user. Specifically, for example, the user may select template information 131 matching conditions of a system that the user desires to construct from the plurality of pieces of template information 131 stored in the information storage area 130 and may issue an instruction to create the system based on the selected template information 131.

The template acquiring unit 112 of the management server 1 acquires, for example, a template describing definition information for deploying the virtual machine 3. Specifically, the template acquiring unit 112 refers to the information storage area 130 and acquires template information 131 corresponding to the creation instruction received by the creation instruction receiving unit 111.

The monitored object specifying unit 113 of the management server 1 specifies a monitored object to be monitored by the monitoring device 6 from, for example, the definition information described in the template information 131 acquired by the template acquiring unit 112.

The monitoring design creating unit 114 of the management server 1 creates, for example, monitoring design information 133 including contents of monitoring to be performed on the monitored object specified by the monitored object specifying unit 113 from monitoring information 132 which associates information related to the monitored object specified by the monitored object specifying unit 113 with information on monitoring items that can be monitored by the monitoring device 6. For example, the monitoring design creating unit 114 stores the monitoring design information 133 in the information storage area 130. Details of the monitoring information 132 and the monitoring design information 133 will be given later.

The user information requesting unit 115 of the management server 1 requests the user to input necessary information when, for example, the monitoring design creating unit 114 creates the monitoring design information 133.

The template changing unit 116 of the management server 1 creates, for example, monitoring definition information obtained by converting contents of the monitoring design information 133 into information that can be described in the template information 131. For example, the template changing unit 116 adds the description of the monitoring definition information created by the monitoring design creating unit 114 to the template information 131 based on the creation instruction received by the creation instruction receiving unit 111.

The virtual machine creation instructing unit 117 of the management server 1 deploys the virtual machines 3 based on, for example, the template information 131 to which the description of the monitoring definition information has been added. For example, the virtual machine creation instructing unit 117 stores the monitoring design information 133 created by the monitoring design creating unit 114 as monitoring design information 233 in the information storage area 230 of the physical machine 2. Furthermore, for example, the virtual machine creation instructing unit 117 stores the template information 131 including the monitoring definition information created by the template changing unit 116 as template information 231 in the information storage area 230 of the physical machine 2.

For example, the auto-scaling executing unit 118 of the management server 1 periodically acquires information related to an operational state of the virtual machines 3 acquired by a monitoring agent installed in each of the virtual machines 3 and determines whether or not the acquired information satisfies the conditions described in the template information 231. For example, when the acquired information satisfies conditions for creating a virtual machine 3, the auto-scaling executing unit 118 instructs the virtualization software 4 to create a new virtual machine 3. Furthermore, for example, when the acquired information satisfies conditions for deleting a virtual machine 3, the auto-scaling executing unit 118 instructs the virtualization software 4 to delete a virtual machine. Accordingly, the auto-scaling executing unit 118 can create a virtual machine 3 only when a virtual machine 3 must be (is) created to provide a service. The auto-scaling executing unit 118 can delete a virtual machine 3 that is no longer necessary. Therefore, resources of the physical machine 2 can be conserved.

Moreover, the auto-scaling executing unit 118 may be configured to manage the virtual machines 3 running in the physical machine 2 in units of a plurality of groups and determine whether or not to create or delete a virtual machine for each group. In other words, for example, when virtual machines that function as a load balancer, a web server, and a database server respectively exist in the virtual machines 3 running in the physical machine 2, the auto-scaling executing unit 118 divides the respective virtual machines 3 into groups corresponding to the functions. For example, when an operational state of a virtual machine 3 functioning as a web server satisfies conditions for creating a new virtual machine 3, the auto-scaling executing unit 118 may create only a virtual machine 3 that functions as a web server.

[Functions of Virtualization Software]

The virtual machine creating unit 211 of the virtualization software 4 creates, for example, a new virtual machine 3 in the physical machine 2. Specifically, when the virtual machine creating unit 211 receives an instruction to create a new virtual machine 3 from the auto-scaling executing unit 118 of the management server 1, the virtual machine creating unit 211 creates a new virtual machine 3 using resources of the physical machine 2.

The virtual machine deleting unit 212 of the virtualization software 4 deletes, for example, a virtual machine 3 running in the physical machine 2. Specifically, when the virtual machine deleting unit 212 receives an instruction to delete a virtual machine 3 from the auto-scaling executing unit 118 of the management server 1, the virtual machine deleting unit 212 deletes a virtual machine 3.

[Functions of Virtual Machine]

For example, when the initial process executing unit 221 of a virtual machine 3 recognizes that the virtual machine 3 is a newly created virtual machine 3, the initial process executing unit 221 installs a monitoring agent in the new virtual machine 3. The monitoring agent is configured to, for example, periodically transmit information related to an operational state of the virtual machine 3 in which the monitoring agent is installed to the monitoring device 6. Specifically, the monitoring agent transmits a log output in the virtual machine 3 in which the monitoring agent is installed, usage of resources (a CPU, a memory, and the like) of the virtual machine 3 in which the monitoring agent is installed, or the like to the monitoring device 6. Accordingly, the monitoring device 6 can comprehend the operational state of the virtual machine 3 in which the monitoring agent has been installed. The monitoring device 6 can start monitoring the virtual machine 3 in which the monitoring agent has been installed. Moreover, for example, the initial process executing unit 221 may be configured to additionally install software other than the monitoring agent (software necessary for providing (used to provide) a service or the like) when installing the monitoring agent.

For example, when the initial process executing unit 221 installs a monitoring agent, the information acquiring unit 222 of the virtual machine 3 acquires identification information 232 for identifying the newly created virtual machine 3. As the identification information 232, for example, an IP address of a monitored object (virtual machine 3) is acquired. Specifically, for example, when the management server 1 performs allocation of IP addresses, the information acquiring unit 222 acquires an IP address by requesting the management server 1 to allocate an IP address.

For example, the information transmitting unit 223 of the virtual machine 3 transmits the identification information 232 of the monitored object acquired by the information acquiring unit 222 to the monitoring device 6. Accordingly, the monitoring device 6 can identify a monitored object and communicate with the monitored object. Therefore, the monitoring device 6 can monitor the monitored object based on the identification information 232. The information transmitting unit 223 may be configured to transmit the monitoring design information 233 together with the identification information 232 to the monitoring device 6. Moreover, the monitoring device 6 may be configured to start monitoring the virtual machine 3 that is identified by identification information 232 in accordance with receiving the identification information 232 from the information transmitting unit 223.

For example, when the virtual machine 3 performs a process of deleting the virtual machine 3 itself with the virtual machine deleting unit 212, the deletion notifying unit 224 of the virtual machine 3 notifies the monitoring device 6 to that effect. Accordingly, the monitoring device 6 can obtain information related to the virtual machine 3 to be deleted. Subsequently, the monitoring device 6 can end monitoring of the virtual machine 3 to be deleted.

[First Embodiment]

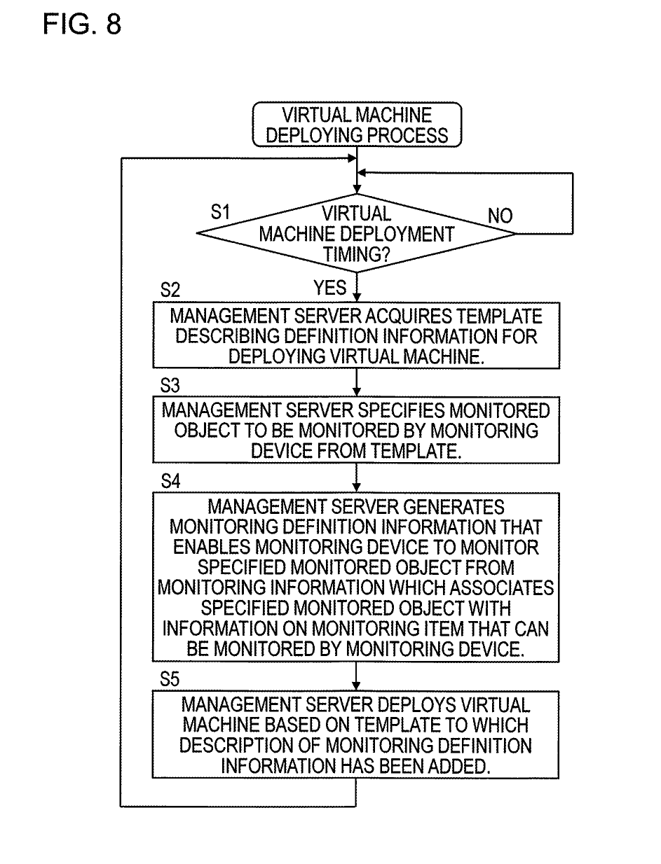

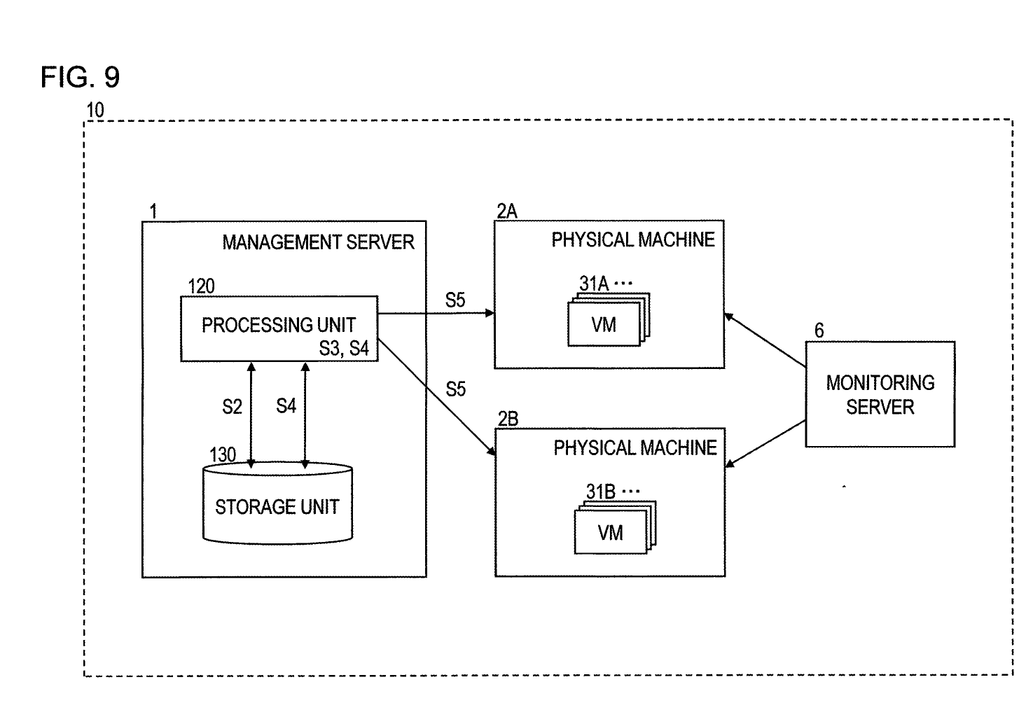

Next, a first embodiment will be described. FIG. 8 is a flow chart illustrating an outline of a virtual machine deploying process according to the first embodiment. FIG. 9 is a diagram for explaining an outline of a virtual machine deploying process according to the first embodiment. The outline of the virtual machine deploying process illustrated in FIG. 8 will now be described with reference to FIG. 9. Moreover, for FIG. 9, only differences thereof from FIG. 2 will be described.

First, as illustrated in FIGS. 8 and 9, for example, the management server 1 (processing unit 120) stands by until a deployment timing of a virtual machine 3 as described in the template information 131 arrives (NO in 51). The deployment timing of the virtual machine 3 may be when, for example, the management server 1 receives an instruction to create a virtual machine 3 from the user. When the deployment timing of a virtual machine 3 arrives (YES in 51), for example, the management server 1 acquires template information 131 describing definition information for deploying a virtual machine 3 (S2). Specifically, the management server 1 acquires template information 131 corresponding to the creation instruction received from the user.

Next, the management server 1 specifies a monitored object to be monitored by the monitoring device 6 from, for example, the template information 131 (S3). In other words, when the management server 1 deploys a system including the virtual machine 3 based on template information 131, the number of virtual machines 3, applications installed in the virtual machines 3, and the like differ depending on the template information 131 selected by the user or the like. Therefore, the management server 1 specifies a monitored object to be monitored by the monitoring device 6 based on the template information 131 used to deploy the virtual machine 3. Specifically, the management server 1 may be configured to specify a monitored object to be monitored by the monitoring device 6 based on information included in the monitoring information 132 stored in the information storage area 130. A specific example of specifying a monitored object will be described later.

Subsequently, for example, the management server 1 acquires monitoring information 132 which associates the monitored object specified in S3 with information on a monitoring item that can be monitored by the monitoring device 6. Then, the management server 1 generates monitoring definition information including information for monitoring the monitored object specified by the monitoring device 6 from the acquired monitoring information 132 (S4). Monitoring definition information is, for example, information that can be described in template information 131 without modification. In other words, the template information 131 used to perform a deployment of the virtual machine 3 includes information related to a condition under which the monitoring device 6 starts monitoring or ends monitoring of the virtual machine 3. The template information 131 includes information related to specific contents of monitoring performed by the monitoring device 6 on the virtual machine 3.

Furthermore, for example, the management server 1 deploys the virtual machine 3 based on a template to which a description of monitoring definition information has been added (S5). In other words, the management server 1 deploys the virtual machine 3 based on template information 131 including the information related to monitoring described above. Therefore, when deploying the virtual machine 3, the management server 1 can cause the virtual machine 3 to be deployed to execute a process of monitoring whether creation or deletion of a virtual machine 3 has occurred. Accordingly, when creation or deletion of a virtual machine 3 occurs, the virtual machine 3 can voluntarily notify the monitoring device 6. Therefore, the monitoring device 6 no longer needs to monitor the creation or deletion of a virtual machine 3 that is a monitored object and a load caused by monitoring virtual machines can be reduced.

As described above, according to the first embodiment, the management server 1 acquires a template in which definition information for deploying a virtual machine 3 is described and specifies a monitored object to be monitored by the monitoring device 6 from the acquired template. Based on monitoring information 132 which associates the specified monitored object with monitoring item information, the management server 1 generates monitoring definition information that enables the monitoring device 6 to monitor the specified monitored object, and deploys the virtual machine 3 based on a template to which a description of the monitoring definition information has been added. Accordingly, when creation or deletion of a virtual machine 3 occurs, the virtual machine 3 can voluntarily notify the monitoring device 6. Therefore, the monitoring device 6 need no longer monitor the creation or deletion of a virtual machine 3 that is a monitored object and a load caused by monitoring virtual machines can be reduced.

[Details of First Embodiment]

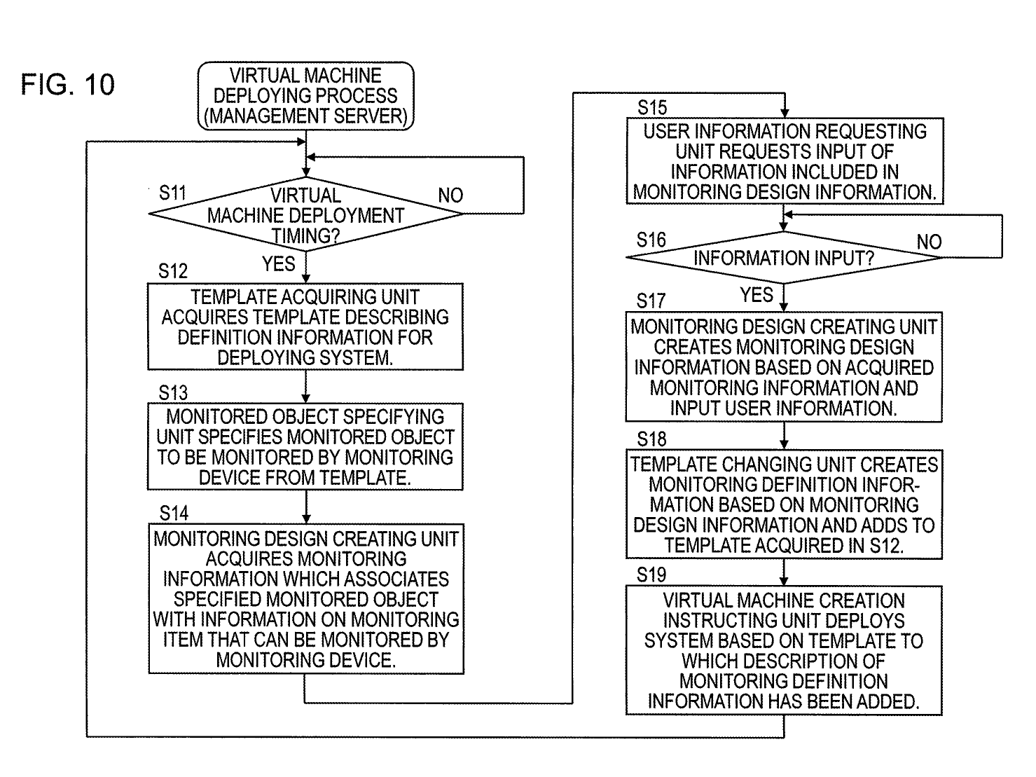

Next, details of the first embodiment will be described. FIGS. 10 to 12 are flow charts describing details of the virtual machine deploying process according to the first embodiment. FIGS. 13 to 20 are diagrams describing details of the virtual machine deploying process according to the first embodiment. Details of the virtual machine deploying process illustrated in

FIGS. 10 to 12 will now be described with reference to FIGS. 13 to 20.

[Processes by Management Server]

First, as illustrated in FIG. 10, the creation instruction receiving unit 111 of the management server 1 stands by until, for example, a deployment timing of a virtual machine 3 as described in template information 131 arrives (NO in S11). When the deployment timing of a virtual machine 3 arrives (YES in S11), for example, the template acquiring unit 112 of the management server 1 acquires template information 131 describing definition information for deploying a virtual machine 3 (S12). Specifically, the management server 1 acquires template information 131 corresponding to the creation instruction received from the user. Hereinafter, a configuration of the template information 131 will be described.

[Template Information]

FIG. 13 is a diagram explaining a specific example of a configuration of the template information 131. Hereinafter, template information 131 for constructing a system including a virtual machine 3 which functions as a load balancer (hereinafter, also referred to as an LB) that monitors a load on each virtual machine 3 and virtual machines 3 which function as a web server and a database server (hereinafter, also referred to as a DB server) will be described as an example.

The template information 131 illustrated in FIG. 13 includes LB template information 141 (hereinafter, also simply referred to as template information 141) for creating a virtual machine 3 that functions as an LB. The template information 131 illustrated in FIG. 13 includes web template information 142 (hereinafter, also simply referred to as template information 142) for creating a virtual machine 3 that functions as a web server. Furthermore, the template information 131 illustrated in FIG. 13 includes DB template information 143 (hereinafter, also simply referred to as template information 143) for creating a virtual machine 3 that functions as a DB server.

The template information 142 includes, for example, information related to the number of created virtual machines 3 that function as web servers (for example, three) and information related to resources of a physical machine to be allocated to each virtual machine 3 (for example, information for specifying a memory area to be allocated). The template information 143 includes, for example, information related to the number of created virtual machines 3 that function as DB servers and information related to resources of a physical machine to be allocated to each virtual machine 3. Furthermore, the template information 141 includes, for example, information related to the number of created virtual machines 3 that function as LBs and information related to resources of a physical machine to be allocated to each virtual machine 3. Subsequently, a deployment machine (not illustrated) having received an instruction from the management server 1 creates the respective virtual machines 3 based on the pieces of template information 141, 142, and 143.

In FIG. 13, the template information 142 includes initial process definition information 152 and the template information 143 includes initial process definition information 153.

The pieces of initial process definition information 152 and 153 include, for example, information that enables the program 210 to run on a newly created virtual machine 3. Specifically, the virtual machine 3 refers to the pieces of initial process definition information 152 and 153 when the management server 1 deploys the virtual machine 3 in the physical machine 2 based on the template information 131. The virtual machine 3 runs the respective functions (virtual machine creating unit 211 and the like) described with reference to FIG. 7 based on contents of the pieces of initial process definition information 152 and 153. Accordingly, the virtual machine 3 can automatically exhibit the respective functions described with reference to FIG. 7 with the deployment of the virtual machine 3.

The pieces of initial process definition information 152 and 153 may include, for example, creation definition information that defines a condition for creating a new virtual machine 3 and deletion definition information that defines a condition for deleting a virtual machine 3. Specifically, for example, the creation definition information includes a condition for newly creating a virtual machine 3 for each of a virtual machine 3 that functions as an LB, a virtual machine 3 that functions as a web server, and a virtual machine 3 that functions as a DB server. In other words, for example, “CPU usage in all virtual machines 3 functioning as a web server exceeding 50%” may be set in the creation definition information as a condition for newly creating a virtual machine 3. For example, “CPU usage in all virtual machines 3 functioning as a DB server exceeding 70%” may be set in the creation definition information as a condition for newly creating a virtual machine 3. Furthermore, for example, the deletion definition information includes a condition for deleting a virtual machine 3 for each of a virtual machine 3 that functions as an LB, a virtual machine 3 that functions as a web server, and a virtual machine 3 that functions as a DB server. Specifically, for example, “CPU usage in all virtual machines 3 functioning as a web server falling below 10%” may be set in the deletion definition information as a condition for deleting a virtual machine 3.

Returning to FIG. 10, the monitored object specifying unit 113 of the management server 1 specifies a monitored object to be monitored by the monitoring device 6 from, for example, the template information 131 (S13). For example, the monitoring design creating unit 114 of the management server 1 acquires monitoring information 132 which associates the monitored object specified in S13 with information on a monitoring item that can be monitored by the monitoring device 6 among the monitoring information 132 stored in the information storage area 130 (S14). Hereinafter, specific examples of the processes of S13 and S14, in case of a portion of the monitoring design information 133 is created in S14, will be described.

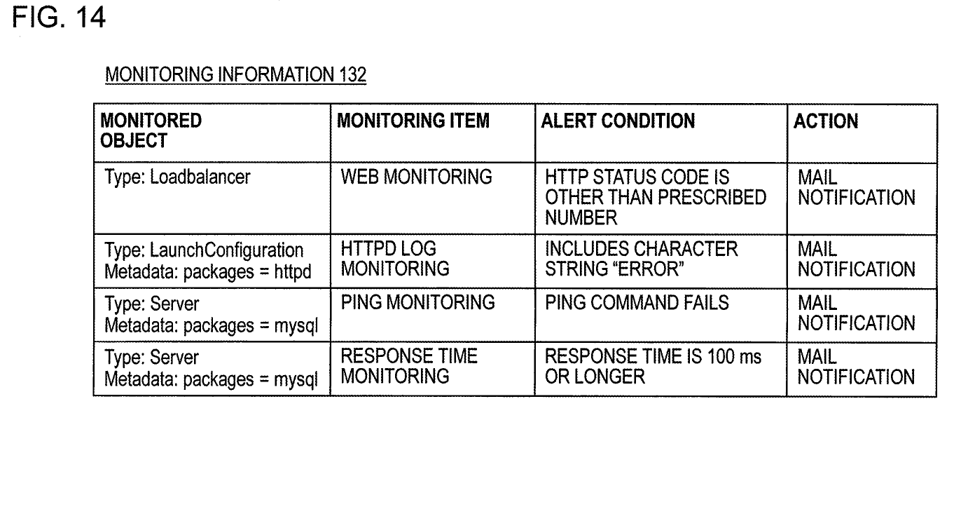

FIG. 14 is a diagram explaining a specific example of monitoring information 132. The monitoring information 132 illustrated in FIG. 14 includes, as items, the “monitored object”, the “monitoring item”, the “alert condition”, and the “action” of the monitoring design information described with reference to FIG. 3. In the “monitored object” of the monitoring information 132 illustrated in FIG. 14, “Type: Loadbalancer” represents a virtual machine 3 that functions as an LB. “Type: LaunchConfiguration Metadata: packages=httpd” represents software specified by “httpd” among software running on a virtual machine 3 that functions as a web server. Furthermore, “Type: Server Metadata: packages=mysql” represents software specified by “mysql” among software running on a virtual machine 3 that functions as a DB server.

Specifically, for information in which “Type: Loadbalancer” is set as the “monitored object”, “web monitoring” is set as the “monitoring item”, “HTTP status code is other than prescribed number” is set as the “alert condition”, and “mail notification” is set as the “action”. In other words, this information indicates that, when “Type: Loadbalancer” is included in the template information 131, a virtual machine 3 that functions as an LB must be (is) monitored. In this case, the monitoring device 6 monitors the virtual machine 3 that functions as an

LB by “web monitoring”, and when the “HTTP status code is other than prescribed number” is set as the “alert condition”, performs a “mail notification” to the user with respect to the occurred phenomenon. A description of other pieces of information illustrated in FIG. 14 will be omitted.

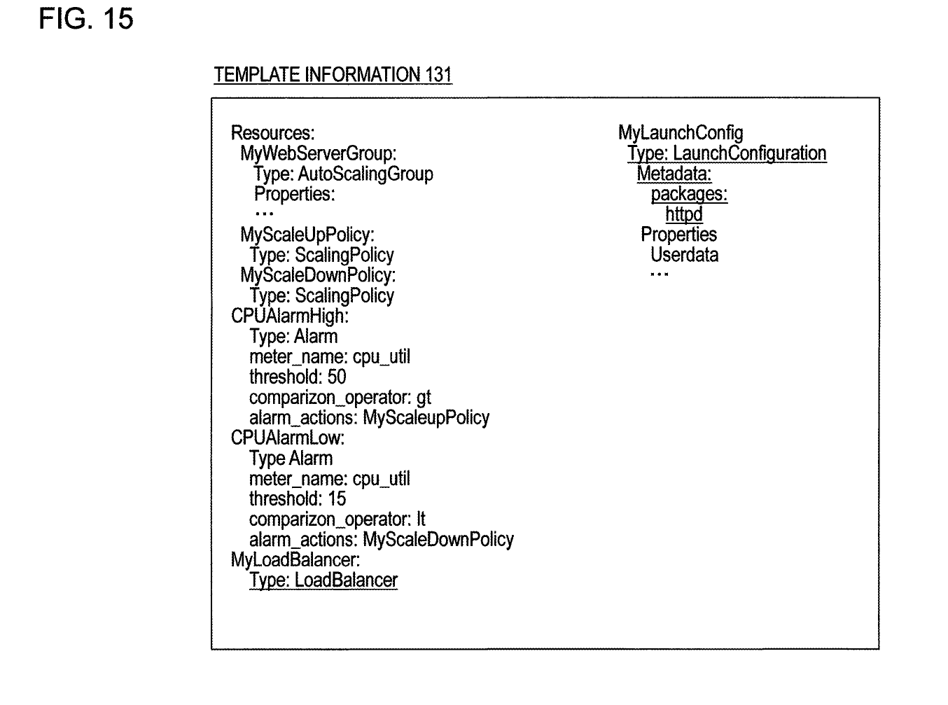

FIG. 15 is a diagram explaining a specific example of the template information 131. Information corresponding to the configuration of the template information 131 described with reference to FIG. 13 is described in the template information 131 illustrated in FIG. 15.

In S13 in FIG. 10, the monitored object specifying unit 113 determines whether or not information (character string) set to the “monitored object” of the monitoring information 132 illustrated in FIG. 14 is included in the template information 131. The monitored object specifying unit 113 specifies the “monitored object” whose information is included in the template information 131 as a monitored object to be monitored by the monitoring device 6. Specifically, a character string made up of “Type: LoadBalancer” and “Type: LaunchConfiguration Metadata: packages=httpd” is included in the template information 131 illustrated in FIG. 15 (underlined portion in FIG. 15). Therefore, for example, by referring to the monitoring information 132 illustrated in FIG. 14, the monitored object specifying unit 113 specifies a virtual machine 3 that functions as an LB and software specified by “httpd” among software running on a virtual machine 3 that functions as a web server as monitored objects.

Next, as illustrated in S14 in FIG. 10, the monitoring design creating unit 114 acquires the information related to the monitored objects specified from the template information 131 illustrated in FIG. 15 and the monitoring information 132 illustrated in FIG. 14. Subsequently, for example, the monitoring design creating unit 114 creates monitoring design information 133 that enables the monitoring device 6 to monitor the monitored objects from the information related to the monitored objects specified from the template information 131 and the monitoring information 132.

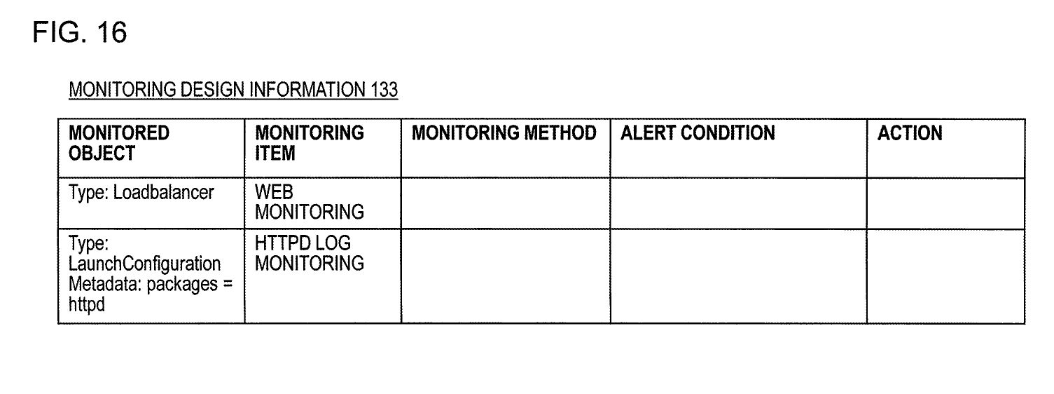

FIG. 16 represents a specific example of the monitoring design information 133 created in S14. The monitoring design information 133 illustrated in FIG. 16 includes, as items, the “monitored object”, the “monitoring method”, the “monitoring item”, the “alert condition”, and the “action” of the monitoring information described with reference to FIG. 3. Specifically, the monitoring design creating unit 114 extracts a “monitored object” which had been included as a character string in the template information 131 among the “monitored objects” of the monitoring information 132 illustrated in FIG. 14 and sets the extracted “monitored object” as the “monitored object” of the monitoring design information 133. Therefore, “Type: LoadBalancer” and “Type: LaunchConfiguration Metadata: packages=httpd” are set to the “monitored object” of the monitoring design information 133 illustrated in FIG. 16.

Furthermore, as illustrated in FIG. 16, the monitoring design creating unit 114 sets a “monitoring item” corresponding to the information set as the “monitored object” of the monitoring design information 133. For example, the monitoring design creating unit 114 may be configured to refer to the monitoring information 132 illustrated in FIG. 14 and acquire and set the “monitoring item” corresponding to the information set as the “monitored object” in the monitoring design information 133. Specifically, the monitoring design creating unit 114 sets “web monitoring” as the “monitoring item” corresponding to “Type: LoadBalancer” that is the “monitored object”. The monitoring design creating unit 114 sets “HTTPD log monitoring” as the “monitoring item” corresponding to “Type: LaunchConfiguration Metadata: packages=httpd” that is the “monitored object”.

Returning to FIG. 10, for example, the user information requesting unit 115 requests the user to input information to be set as the “monitoring method”, the “alert condition”, and the “action” of the monitoring design information 133 (S15). Subsequently, the user information requesting unit 155 stands by until, for example, information to be set in the monitoring design information 133 or information to the effect that initial values are to be used is input (NO in S16). As the initial values, for example, information set in advance in the monitoring information 132 or the like may be used. Specifically, in the information whose “monitored object” is “Type: LoadBalancer” in the monitoring information 132 illustrated in FIG. 14, “HTTP status code is other than prescribed number” and “mail notification” may be adopted as initial values.

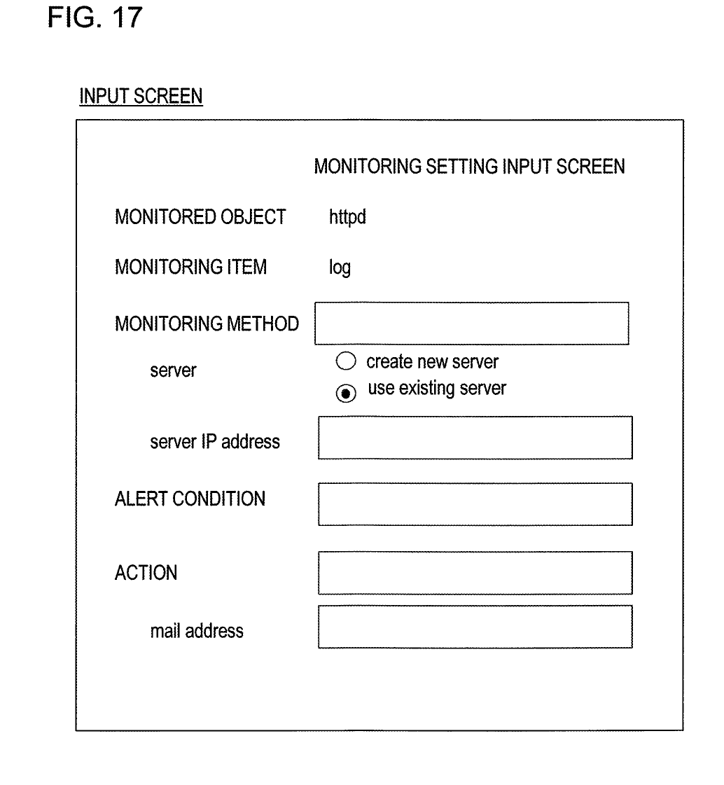

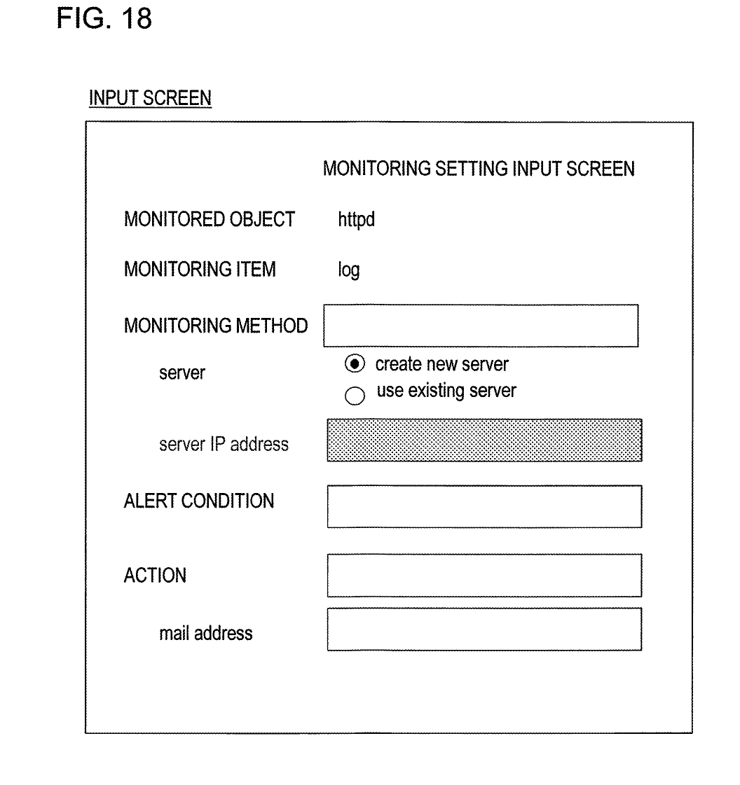

FIGS. 17 and 18 illustrate a screen through which the user information requesting unit 115 requests the user to input information. In other words, the input screen illustrated in FIGS. 17 and 18 is a screen for requesting input of information to be set in the monitoring design information 133 illustrated in FIG. 16. Hereinafter, an input screen in a case where input of information whose “monitored object” is “Type: LoadBalancer” among the monitoring design information 133 illustrated in FIG. 16 is requested will be described.

A “monitored object”, a “monitoring item”, a “monitoring method”, “alert information”, and an “action” are displayed as major items on the input screen illustrated in FIG. 17. As minor items corresponding to the “monitoring method”, “server” for selecting any of “create new server” which represents the creation of a new monitoring device 6 and “use existing server” which represents the use of an existing monitoring device 6 is displayed on the input screen illustrated in FIG. 17. Furthermore, “server IP address” for inputting an IP address of a selected monitoring device 6 in a case where “use existing server” is selected as the minor item corresponding to the “monitoring method” is displayed. In addition, “mail address” for inputting a mail address of the user is displayed as a minor item corresponding to the “action” on the input screen illustrated in FIG. 17.

The input screen illustrated in FIG. 17 may be linked with contents of the monitoring design information 133 illustrated in FIG. 16. Therefore, information is already set to the “monitored object” and the “monitoring item” in the monitoring design information 133 illustrated in FIG. 16. Specifically, in the example illustrated in FIG. 17, “httpd” denoting “TYPE: LaunchConfiguration Metadata: packages=httpd” is already displayed as information corresponding to the “monitored object”. In addition, “log” denoting “HTTPD log monitoring” is already displayed as information corresponding to the “monitoring item”.

On the input screen illustrated in FIG. 17, information corresponding to the “monitoring method”, the “alert condition”, and the “action” is left blank. Therefore, the user inputs information left blank among the input screen illustrated in FIG. 17. Accordingly, the monitoring design creating unit 114 can acquire information that is not set among the monitoring design information 133.

Moreover, when the user selects “create new server” on the input screen illustrated in FIG. 17, for example, input of information in the “server IP address” field may be disabled as illustrated in FIG. 18. On the input screen illustrated in FIG. 17, the user information requesting unit 115 may display options that can be input to each blank on the screen in advance. In this case, the user can easily input information based on the options displayed on the screen.

Returning to FIG. 10, when information to be set to the monitoring design information 133, information to the effect that initial values are to be used, or the like is input (YES in S16), the monitoring design creating unit 114 creates, for example, the monitoring design information 133 (S17). Specifically, the monitoring design creating unit 114 creates the monitoring design information 133 based on the monitoring information 132 acquired in S14 and the user information input in S16.

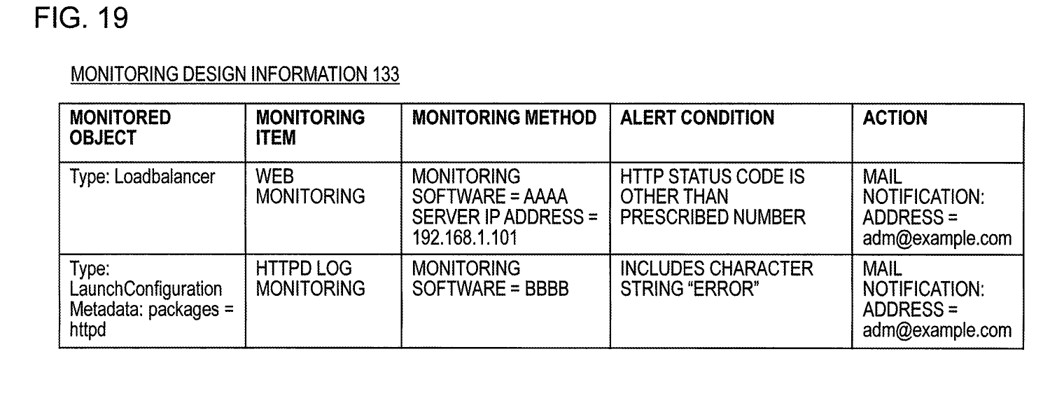

FIG. 19 is a diagram explaining monitoring design information 133 in a case where the user information input in S16 is set to the monitoring design information 133 to which the monitoring information 132 acquired in S14 is set.

Specifically, the monitoring design creating unit 114 sets information input to the input screen illustrated in FIG. 17 to the “monitored object”, the “alert condition”, and the “action” of the monitoring design information 133 illustrated in FIG. 19. For example, for information whose “monitored object” is “Type: LoadBalancer” among the monitoring design information 133 illustrated in FIG. 19, “monitoring software=AAAA” that is information input to the input screen described with reference to FIG. 17 is set to the “monitoring method”. In addition, “192.168.1.101” that is information input to the “server IP address” on the input screen described with reference to FIG. 17 is set to the “monitoring method”. Furthermore, “HTTP status code is other than prescribed number” that is information input on the input screen described with reference to FIG. 17 is set to the “alert condition”. Moreover, “mail notification” that is information input on the input screen described with reference to FIG. 17 is set to the “action”. In addition, “adm@example.com” that is information input to the “mail address” on the input screen described with reference to FIG. 17 is set to the “action”. A description of other pieces of information illustrated in FIG. 19 will be omitted.

In other words, the monitoring design creating unit 114 creates monitoring design information 133 to be used by the monitoring device 6 to monitor the monitored object based on the template information 131 corresponding to the virtual machine 3 to be created and on information input by the user.

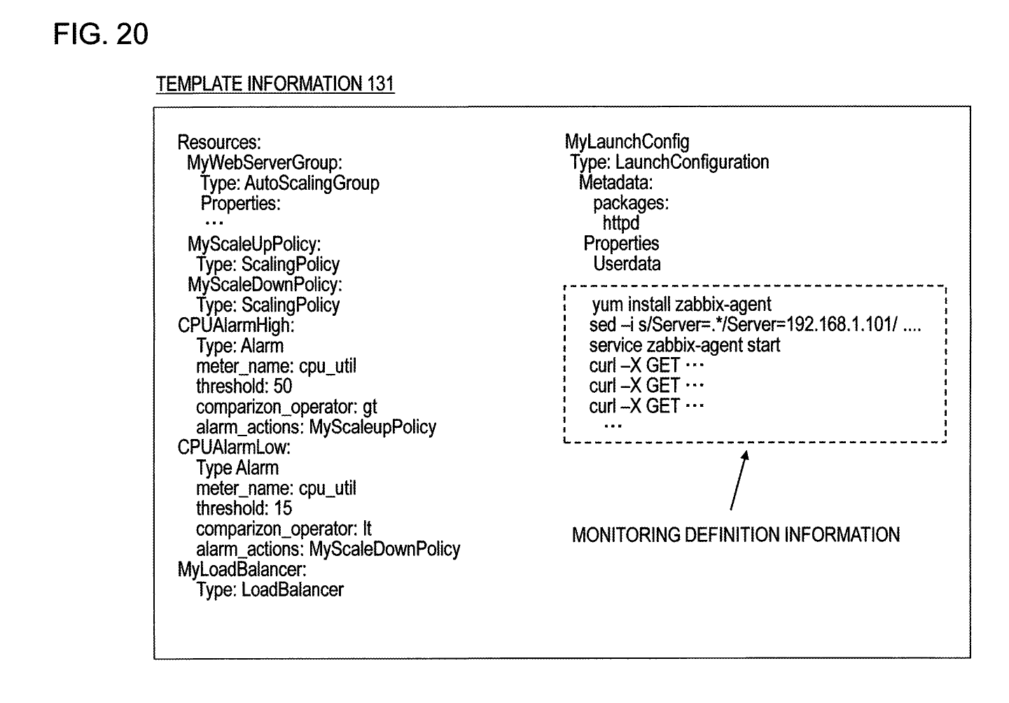

Returning to FIG. 10, the template changing unit 116 creates monitoring definition information based on the monitoring design information 133 created in S17 (S18). Monitoring definition information is information that can be described in the template information 131. In other words, the template changing unit 116 converts the monitoring design information 133 created in S17 into monitoring definition information that is information that can be described in the template information 131. Accordingly, the monitoring design creating unit 114 can include information that enables the monitoring device 6 to monitor the monitored object in the template information 131 for creating a virtual machine 3. Subsequently, for example, the template changing unit 116 adds a description (a dotted portion in FIG. 20) of monitoring definition information to the template information 131 acquired in S12 as illustrated in FIG. 20. The virtual machine creation instructing unit 117 of the management server 1 deploys the virtual machines 3 based on, for example, the template information 131 to which the description of the monitoring definition information has been added (S19).

[Process at Virtual Machine and Virtualization Software]

Next, a virtual machine monitoring process at the virtual machine 3 and the virtualization software 4 will be described.

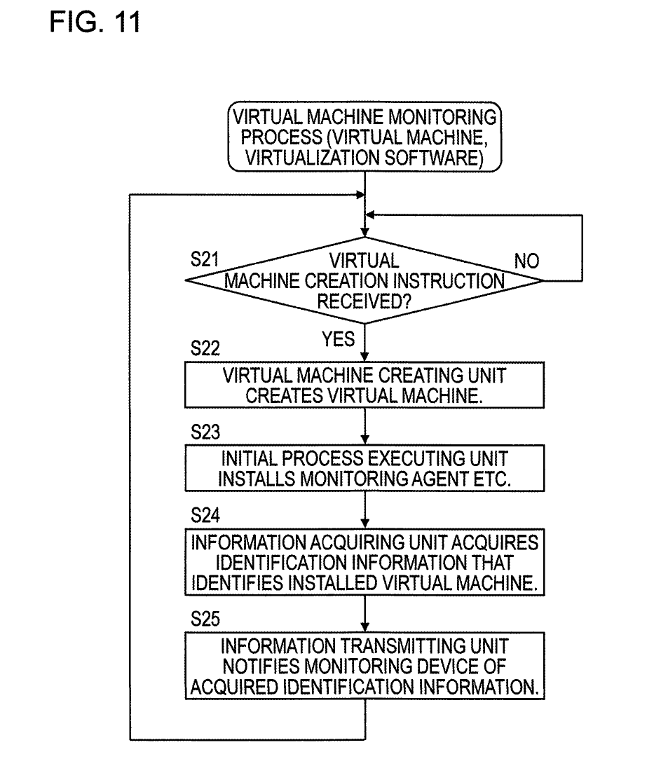

First, as illustrated in FIG. 11, the virtual machine creating unit 211 of the virtualization software 4 stands by until, for example, an instruction to create a new virtual machine 3 is received from the auto-scaling executing unit 118 of the management server 1 (NO in S21). When the instruction from the auto-scaling executing unit 118 of the management server 1 is received (YES in S21), the virtual machine creating unit 211 of the virtualization software 4 creates, for example, a virtual machine 3 based on the received instruction (S22).

Subsequently, when creation of the virtual machine 3 is completed (YES), for example, the initial process executing unit 221 of the newly created virtual machine 3 installs software such as a monitoring agent based on contents of the template information 231 (S23) or, in other words, the initial process executing unit 221 installs a monitoring agent or the like according to monitoring definition information included in the template information 131. Accordingly, the created virtual machine 3 can voluntarily transmit information related to an operational state to the monitoring device 6. Therefore, the monitoring device 6 can acquire information related to the virtual machine 3 to be newly monitored without having to monitor whether or not the virtual machine 3 has been created.

The information acquiring unit 222 of the newly created virtual machine 3 acquires, for example, identification information 232 that identifies the created virtual machine 3 (S24). The information transmitting unit 223 of the newly created virtual machine 3 transmits, for example, the identification information 232 acquired by the information acquiring unit 222 to the monitoring device 6 (S25). Accordingly, the monitoring device 6 can identify a monitored object to be monitored (the virtual machine 3 that includes the monitored object). Subsequently, the monitoring device 6 starts monitoring the monitored object based on the received identification information 232 and the monitoring design information 233. Accordingly, the monitoring device 6 can monitor a monitored object to be monitored without omission and without having to monitor whether or not the virtual machine 3 has been created.

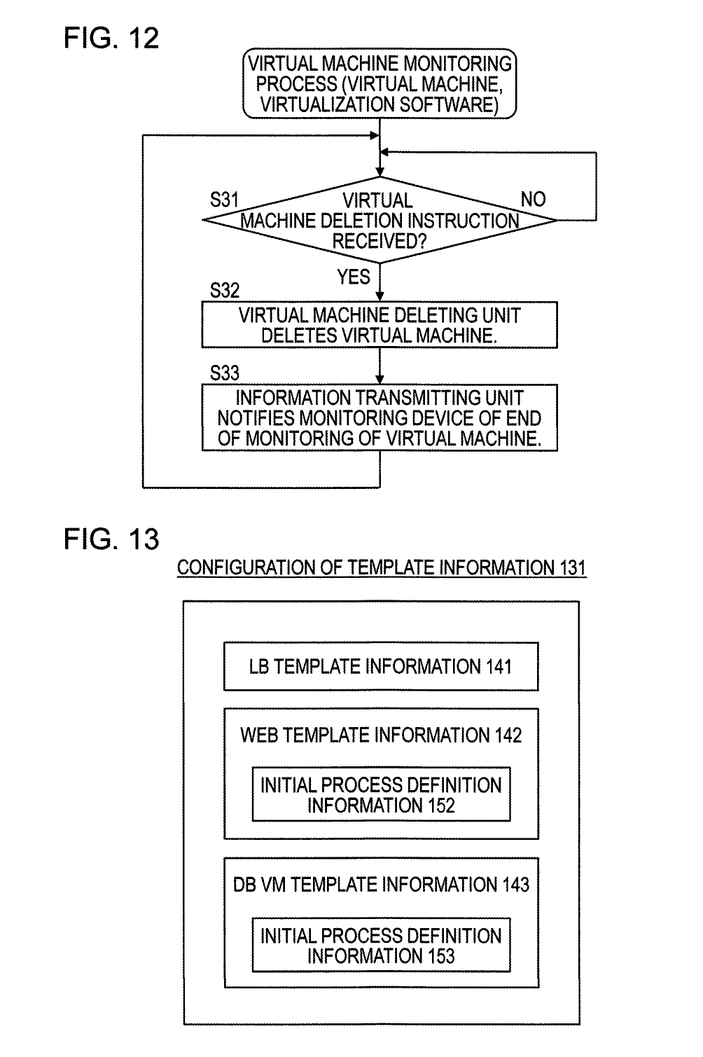

Next, a virtual machine deploying process in a case where a virtual machine 3 that is a monitored object is deleted will be described. As illustrated in FIG. 12, the virtual machine deleting unit 212 of the virtualization software 4 stands by until, for example, an instruction to delete a virtual machine 3 is received from the auto-scaling executing unit 118 of the management server 1 (NO in S31). When the instruction from the auto-scaling executing unit 118 of the management server 1 is received (YES in S31), the virtual machine deleting unit 212 of the virtualization software 4 deletes, for example, a virtual machine 3 based on the received instruction (S32).

Next, the deletion notifying unit 224 of the virtual machine 3 notifies, for example, the monitoring device 6 to the effect that monitoring of the virtual machine 3 itself is to be ended (S33). Subsequently, the monitoring device 6 ends monitoring of the virtual machine 3 having transmitted the notification to the effect that monitoring of the virtual machine 3 itself is to be ended. Accordingly, the monitoring device 6 can end monitoring of a monitored object that need no longer be monitored without having monitored whether or not the virtual machine 3 that is the monitored object has been deleted.

As described above, according to the first embodiment, the management server 1 acquires a template in which definition information for deploying a virtual machine 3 is described and specifies a monitored object to be monitored by the monitoring device 6 from the acquired template. Based on monitoring information 132 which associates the specified monitored object with monitoring item information, the management server 1 generates monitoring definition information that enables the monitoring device 6 to monitor the specified monitored object, and deploys the virtual machine 3 based on a template to which a description of the monitoring definition information has been added. Accordingly, when creation or deletion of a virtual machine 3 occurs, the virtual machine 3 can voluntarily notify the monitoring device 6. Therefore, the monitoring device 6 need no longer monitor the creation or deletion of a virtual machine 3 that is a monitored object and a load caused by monitoring virtual machines can be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is the claimed is:

1. A virtual machine deployment method comprising:
acquiring, by a processor, a template in which definition information is described for deploying a virtual machine;
specifying, by a processor, a monitored object to be monitored by a monitoring device from information included the acquired template;
generating, by a processor, monitoring definition information that enables the monitoring device to monitor the specified monitored object from monitoring information which associates the specified monitored object with information on a monitoring item that can be monitored by the monitoring device; and
deploying, by a processor, the virtual machine based on the acquired template to which a description of the generated monitoring definition information has been added.

2. The virtual machine deployment method according to claim 1, further comprising:
after the deploying the virtual machine, transmitting, by the specified monitored object, identification information that identifies the specified monitored object to the monitoring device, and
monitoring, by the monitoring device, the specified monitored object by referring the identification information that has been transmitted by the specified monitored object and the monitoring definition information.

3. The virtual machine deployment method according to claim 2, wherein the monitoring device is a virtual machine included in the deployed virtual machine.

4. The virtual machine deployment method according to claim 2, further comprising:
when the monitored object is deleted after the monitoring the monitored object, instructing, by the monitored object to be deleted, the monitoring device to end the monitoring of the monitored object to be deleted.

5. A non-transitory computer-readable storage medium storing therein a virtual machine deployment program for causing a computer to execute processes comprising:
acquiring a template in which definition information is described for deploying a virtual machine;
specifying a monitored object to be monitored by a monitoring device from information included the acquired template;
generating monitoring definition information that enables the monitoring device to monitor the specified monitored object from monitoring information which associates the specified monitored object with information on a monitoring item that can be monitored by the monitoring device; and
deploying the virtual machine based on the acquired template to which a description of the monitoring definition information has been added.

6. The non-transitory computer-readable storage medium storing therein a virtual machine deployment program according to claim 5, wherein
after the deploying the virtual machine, the specified monitored object transmits identification information that identifies the specified monitored object to the monitoring device, and
the monitoring device monitors the specified monitored object by referring the identification information that has been transmitted by the specified monitored object and the monitoring definition information.

7. The non-transitory computer-readable storage medium storing therein a virtual machine deployment program according to claim 5, wherein when the monitored object is deleted after the monitoring the monitored object, the monitored object to be deleted instructs the monitoring device to end the monitoring of the monitored object to be deleted.

8. A virtual machine deployment system comprising:
a first physical machine; and
a second physical machine that is accessible to and from the first physical machine, wherein
the first physical machine acquires a template in which definition information is described for deploying a virtual machine,
the first physical machine specifies a monitored object to be monitored by a monitoring device from information included the template,
the first physical machine generates monitoring definition information that enables the monitoring device to monitor the specified monitored object from monitoring information which associates the specified monitored object with information on a monitoring item that can be monitored by the monitoring device, and
the second physical machine deploys the virtual machine based on the acquired template to which a description of the monitoring definition information has been added.
